(19) United States
(12) Patent Application Publication
(10) Pub. No.: US 2007/0282663 A1
(43) Pub. Date: Dec. 6, 2007

(54) GROUP PURCHASE PROGRAM SYSTEMS AND METHODS

(75) Inventor: John L. Barlament, Mequon, WI (US)

Correspondence Address: MICHAEL BEST & FRIEDRICH LLP, 100 E WISCONSIN AVENUE, Suite 3300, MILWAUKEE, WI, 53202, US

(73) Assignee: Michael Best Friedrich LLP, Milwaukee, WI (US)

(21) Appl. No.: 11/382,842

(22) Filed: May 11, 2006

(51) Int. Cl. G06F 17/30

(52) U.S. Cl. 705/10

(57) ABSTRACT

A group purchase program systems and methods. The invention discloses methods for sharing the cost of research on topics by identifying, researching, and categorizing a topic. Participants are solicited for purchasing the information discovered in researching the topic. Information on the topic is published and provided to enrolled participants who share the cost of the research. Additional parties may purchase the information on the topic at a later time by paying a premium over the price paid by the enrolled participants.

### BACKGROUND

The relationship between a law firm and its clients is, in general, very private. As a consequence, information about and work product for clients as well as the costs of maintaining and producing the same is not shared freely or efficiently, even among attorneys in the same law firm.

For example, when a first client has a topic requiring legal advice (e.g., a new employment law) the first client may request an attorney to provide advice and guidance on the topic. Or the first client may request the preparation of a new document. The attorney then researches the topic and often creates a document with the findings. In many cases this document will address the topic specifically for the first client. The first client is then billed the full cost for the time spent performing the research and publishing the document with the findings. The topic, however, will often times be applicable to a number of different clients.

Thereafter, a second client may request advice and guidance on the same topic with the attorney. Since the attorney has already completed the research on the topic for the first client, the attorney can generate another document with the findings of the original research. The second client is then billed for the cost of publishing the document. Since the second client is not billed for any of the research, the second client's bill can be much less than the first client's bill, although they both received essentially the same final work product.

Because the second client effectively receives a discount, simply because he inquired about a topic at a later time than the first client, clients may delay obtaining legal advice in the hope that another client requests the same advice first and, therefore, bears the bulk of the costs. In certain circumstances, this delay may act to the client's detriment.

In another scenario, a third client can raise the same topic with a second attorney. The second attorney, unaware that a first attorney has already researched the topic, researches the topic himself. The second attorney then publishes his findings for the third client. The third client is billed for both the research and the publication of the findings. Since the first attorney had already completed the research, the third client could have received the results of the first attorney's research, at a substantially reduced cost.

### SUMMARY

In one embodiment, the invention provides a method of providing information on a topic to a plurality of clients. The method includes identifying a topic of interest, developing a budget for producing a work product on the topic, soliciting interest in the topic from the plurality of clients, offering a right to receive the work product when available, enrolling one or more of the plurality of clients in a program to receive the work product when available, researching the topic, publishing the work product, providing the work product to the enrolled clients, and billing the enrolled clients based on the budget, the number of enrollees, and a fixed fee.

In another embodiment, the invention provides a system for sharing a cost of providing information on a topic amongst a group of interested participants. The system includes a participant database, a topic database, and a computer system. The participant database is comprised of participants potentially interested in a topic. The topic database includes a plurality of unresearched topics and a plurality of published work product. The computer system is configured to receive a new topic, provide the new topic to an identifying function, provide the identified topic to a research function, publish the work product, enroll interested participants to receive the published work product, and provide the published work product to the enrolled participants. The identifying function is configured to provide an identified topic and the research function is configured to provide a work product. The enrolled participants then share the cost of researching the topic and publishing the work product.

In another embodiment, the invention provides a method of sharing a cost of providing a work product on a topic amongst a group of participants in a group purchase program. The method includes submitting the topic to a group purchase program, developing a research budget for the topic, developing a budget for publication of the work product, determining a delivery time for the published work product, framing the topic, categorizing the topic, informing a select group of the plurality of participants about the topic, researching the topic, publishing the work product, enrolling participants to receive the information, and providing the published work product to the enrolled participants.

Other aspects of the invention will become apparent by consideration of the detailed description and accompanying drawings.

### BRIEF DESCRIPTION OF THE DRAWINGS

FIG. 1 is a block diagram of an embodiment of a group purchase program of the invention.

FIG. 2 is a flow chart of an embodiment of a process for implementing the group purchase program of FIG. 1.

FIG. 3 is an exemplary display of a login screen of the group purchase program of FIG. 1.

FIG. 4 is an exemplary display of a user menu screen of the group purchase program of FIG. 1.

FIG. 5 is an exemplary display of a topic entry screen of the group purchase program of FIG. 1.

FIG. 6 is an exemplary display of an available topics screen of the group purchase program of FIG. 1.

FIG. 7 is an exemplary display of an enrollment screen of the group purchase program of FIG. 1.

FIG. 8 is an exemplary display of an enrolled/purchased topics screen of the group purchase program of FIG. 1.

FIG. 9 is an exemplary display of an administrator menu screen of the group purchase program of FIG. 1.

FIG. 10 is an exemplary display of a new topic entry screen of the group purchase program of FIG. 1.

FIG. 11 is an exemplary display of a new topic submission screen of the group purchase program of FIG. 1.

FIG. 12 is an exemplary display of a posted and saved topics screen of the group purchase program of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

Embodiments relate to a group purchase program that enables services to be provided to a number of interested parties with costs being shared equally amongst the interested parties. The group purchase program can also reduce the possibility of duplication of effort at a firm providing the services. While the embodiments shown relate to a law firm and its clients, the group purchase program has application in other situations where multiple customers desire common information or documents.

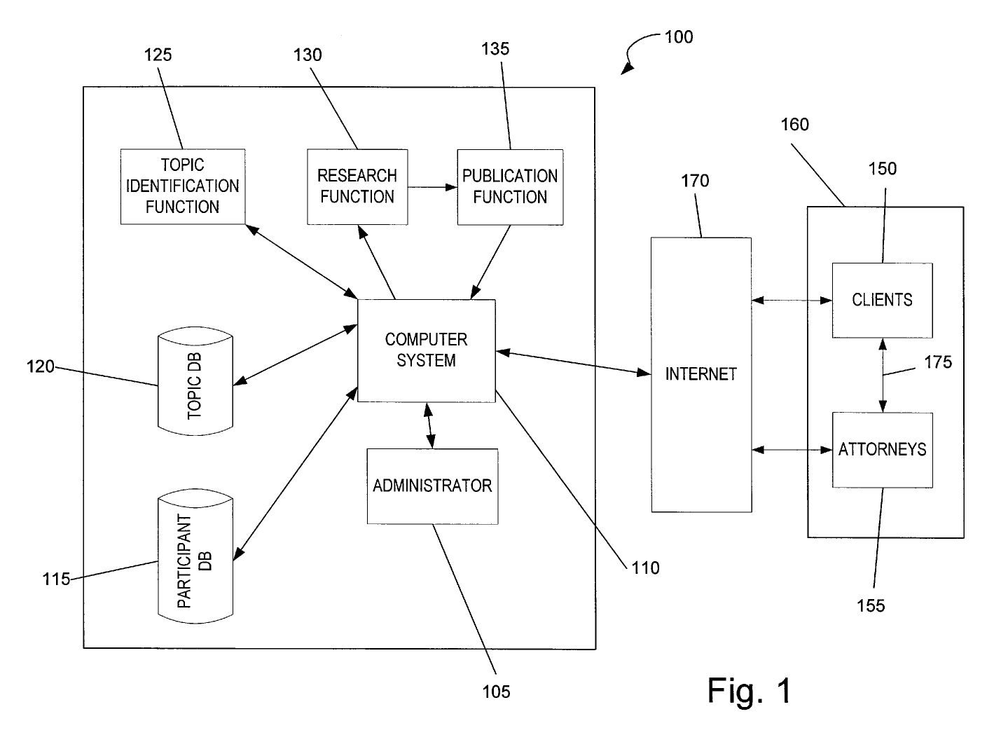

FIG. 1 shows a block diagram of an embodiment of a group purchase program 100. The group purchase program 100 can include at least one administrator 105, a computer system 110, a participant database 115, a topic database 120, a topic identification function 125, a research function 130, and a publication function 135. In addition, a plurality of clients 150, and one or more attorneys 155, form a group of users 160 in the embodiment of the group purchase program 100 shown. Users 160 can access the group purchase program 100 through a network 170, such as the Internet.

Initial creation of the participant database 115, at a firm implementing a group purchase program 100, may include adding all of the firm's clients to the participant database 115. In other embodiments, clients may choose to participate in the group purchase program 100 or may opt to not participate in the group purchase program 100. In some embodiments, non-clients may be allowed to participate in the group purchase program 100 and, therefore, become part of the participant database 115.

Membership in the group purchase program 100 can be provided at no charge or for a fee. Fees can be on an annual subscription basis or a usage basis or a combination of both. Fees can be set for each client individually, for certain clients as a group, or for all clients equally.

The participant database 115 can include a set of information on each participant. In some embodiments, collection of this data is from existing records. In other embodiments, data is solicited directly from clients. Participants can provide the data in a document, electronically, or can enter the data directly on a web page. Access to Internet web pages for the group purchase program 100 may require a login name and a password. The login name and password can be assigned by the firm or chosen by the participant.

In some embodiments, the data collected from participants for the participant database 115, in addition to standard client information, includes: type of industries the client operates in, size of the client's entity or entities, location of the client's corporate headquarters, locations of the client's facilities, operations performed at each facility, and areas the client is interested in. Additional information stored in the participant database may include: fee payment information, login name and password, topics purchased, and topics raised.

In some embodiments, the operation of the group purchase program 100 is controlled through the computer system 110. The participant database 115, which contains information on all of the clients 150 who are participating in the group purchase program 100, is created and controlled through the computer system 110. New participants be can added to the participant database 115 through the computer system 110. Information on participants in the participant database 115 can be modified through the computer system 110. The information on participants contained in the participant database 115 is used by the computer system 110 to determine which clients 150 should be informed of topics based on a topic's assignment to certain categories and a client's interest or relevancy to the assigned categories. In addition, the information in the participant database 115 is used to determine if a client 150 should have access to the group purchase program 100 and the topic database 120.

In some embodiments, the topic database 120 is maintained by the computer system 110 under the direction of the administrator 105. The topic database 120 can include information on all of the topics submitted to the group purchase program 100. The information in the topic database 120 can include a topic, a topic's categorization information, miscellaneous general information, and published data on a topic (if any).

In some embodiments, the administrator 105 manages and maintains the computer system 110 and all of the data of the group purchase program 100. The administrator 105 is responsible for changes to the participant database 115, the flow of topics from the topic database 120 to/from the topic identification function 125, to the research function 130, and from the publication function 135. The administrator 105 also oversees updates and enhancements to the group purchase program 100.

New topics can be submitted to the group purchase program 100, either via a web site or by the administrator 105. In some embodiments, the topics are provided to a topic identification function 125 where they are categorized, budgeted, and, restated (framed) if necessary. The topic identification function 125 can be performed by one or more individuals responsible for topic identification. Topics can be submitted to individuals within the topic identification function 125 on a random basis or as directed (by topic or category) by the administrator 105. In some embodiments, the computer system 110 places newly submitted topics into a general mailbox or, at the direction of the administrator 105, sends a newly submitted topic to a specific individual for processing.

Once a topic has been properly identified, the topic identification function 125 returns the topic, along with any additional information generated (e.g., categories to which the topic belongs) by the topic identification function 125, to the computer system 110. The computer system 110 then adds the topic and its related information to the topic database 120.

An identified topic can be reviewed to determine whether sufficient interest exists in the topic to cover the cost of researching and publishing the topic. In some embodiments, a level of interest is solicited from participants in the participant database 115 who may be likely to purchase the research on the topic. If sufficient interest is not found, the topic can be put on hold until such time as sufficient interest appears or the topic is no longer viable. If the topic becomes no longer viable, the topic is deleted from the topic database. If sufficient interest exists in a topic, the topic is provided to the research function 130. The research function 130 can be performed by one or more individuals responsible for topic research. Topics can be submitted to individuals for research on a random basis or as directed (by topic or category) by the administrator 105. In some embodiments, the topics are placed into a general mailbox or, at the direction of the administrator 105, sent to a specific individual for researching.

Once a topic has been researched, the research function 130 provides the topic to the publication function 135. The publication function 135 can publish the results of the research in several ways including web pages, email messages, letters, brochures, and/or recorded messages. The publication function 135 provides the published works to the computer system 110 which deposits the published works in the topic database 120 with their associated topics. In some embodiments, the publication function 135 is integrated with the research function 130.

The one or more attorneys 155 and the plurality of clients 150 communicate via a communication link 175. The communication link 175 can be a personal, face-to-face conversation, a telephone call, a fax, an email, or other communication mechanism, alone or in combination.

In some embodiments, the users 160 (clients 150 and attorneys 155) interact with the group purchase program 100 via the network 170. The computer system 110 provides access to the group purchase program 100 through a web site on the network 170. Users 160 use the web site to, among other things, submit topics, view and enroll in existing topics, and view previously published data.

The computer system 110 can send an email to users 160 informing them that a topic they have enrolled in has been published. In some embodiments, the email can include, or have an attachment including, the published data.

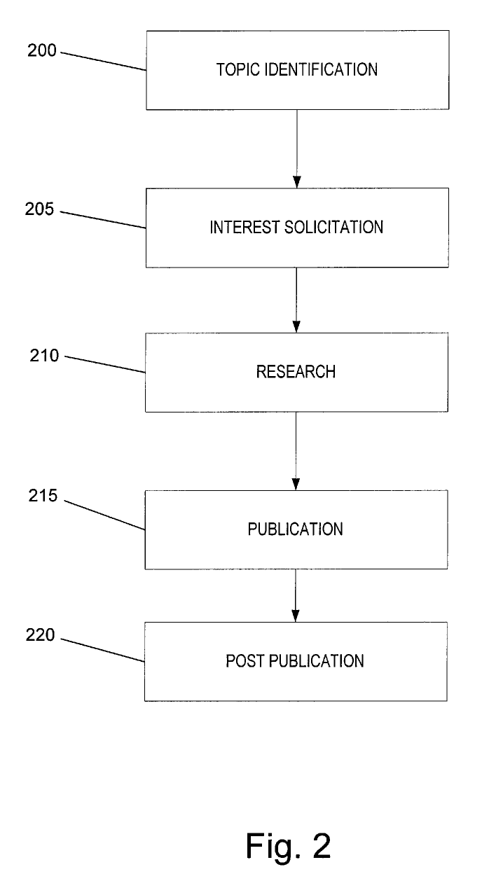

FIG. 2 is a flow chart of an embodiment of a process for a group purchase program 100 which reduces the possibility of duplication of effort and enables clients to share the costs of obtaining legal advice.

In some embodiments, a group legal purchase program 100 begins with the identification of a topic (block 200). Topics addressed by the group purchase program 100 can arise from many sources including: clients 150, attorneys 155, and a firm's marketing department. For example, a client may require legal assistance in the creation of a company handbook. Several clients can be creating or editing company handbooks simultaneously and, therefore, all require legal assistance on the same topic. Alternatively, an attorney may raise a topic when a new law is passed or following an experience with a present law. A firm's marketing department may identify a topic of general interest to clients (e.g., the sale of a business).

Once a topic has been raised, it can be framed for incorporation in the group purchase program 100. The framing process includes one or more individuals reviewing the topic as presented and producing a written statement that encompasses the complete topic. Certain topics may be broken down into a number of sub-topics with or without one main topic. Sub-topics generally must have varied levels of client interest such that some participants are not interested in the sub-topic while other participants have a high level of interest. Sub-topics also must be financially self sufficient. This means that there must be enough value and participant interest in the sub-topic to justify researching and publishing the sub-topic.

In some embodiments, each topic/sub-topic framed above is classified into one or more categories to which it relates. Classification areas may include: practice areas, interested attorneys, geographic location affected, entity size, and industry.

Next an estimated budget can be developed. Each topic/sub-topic is reviewed to determine the time and effort necessary to research the topic and publish the findings. A time budget can be estimated based on the topic. Using the time budget, one or more individuals can be assigned to perform the research. Based on the schedules and costs of the individuals assigned to perform the research, an estimated time of delivery and an estimated total cost can be determined.

Once the topic/sub-topic is identified, framed, classified, and budgeted, interest in the topic/sub-topic can be solicited from participants in the group purchase program (block 205).

In some embodiments, identified and budgeted topics are posted on a firm's website. Participants in the group purchase program access the website and determine which topics they have interest in receiving information on and interested participants enroll to receive the information for those topics when it is published.

In addition, clients with a potential interest in a topic may be contacted by email, telephone, or letter from the firm. A determination of which clients may have an interest in a topic can result from how the topic was classified and how a client's record in the participant database matches that classification. For example, for a topic classified as being employment related, applicable nationally, relevant to companies of all sizes, relevant to companies that manufacture, and relevant to Attorneys A, B, C, and D; all clients with manufacturing operations in the United States for which the firm performs employment work can be contacted to determine if they would be interested in obtaining information on the topic. In addition, Attorneys A, B, C, and D are informed about the topic and may contact their clients directly regarding the topic.

Advertisements and brochures can also be developed, on topics of potential interest to a large number of entities, to inform prospective clients that the firm is addressing the topic. The advertisements and brochures can invite the prospective clients to become a client of the firm and to obtain the information on the topic at a reduced cost.

In some embodiments, parties interested in participating in the group purchase program 100 register at a web page to become a participant in the group purchase program. Participants are then able to enroll, at the website, to receive delivery of the information for a topic when it is published. The web page also includes information on identified topics including: classification information, estimated delivery date, and estimated cost. The web site can also include information for prospective clients and for clients who are not registered on how to become a participant in the group purchase program and on how to enroll for delivery of a information on a topic.

In some embodiments, an estimated cost of the topic information is determined based on the estimated research and publication cost and the number of participants enrolled to receive the information. Additional fees may be added to the estimated cost including fees to cover the overhead of the group purchase program and special fees for non-clients who participate. In some embodiments, clients can choose a maximum amount they are willing to pay for the information. If not enough clients enroll to receive the information, and therefore, reduce the cost below this threshold, the client can choose not receive the information or to pay the higher price and receive the information.

Once it becomes apparent that sufficient interest in the topic exists, the individual or individuals, assigned to perform the research, begin the research (block 210). A deadline and cost budget is assigned based on the figures developed during the topic classification stage above. Once the research is complete, the work product is published (block 215).

In some embodiments, the results of the research are packaged for delivery to participants enrolled in the topic. Methods of publication include: posting the data to a web site, emailing the data to enrolled participants, and sending a letter with the data to enrolled participants. Portions of the research findings may also be used in brochures and other marketing materials. Published results, provided to the general public through marketing materials, should serve to interest non-enrolled parties in becoming participants in the group purchase program and care should be taken to not diminish the value of what is being received by the participants who enrolled in the topic.

In some embodiments, clients can choose how to receive results for the topics in which they have enrolled. Some forms of publication can be provided to enrollees at no additional cost beyond the cost determined by the cost of the research and publishing and the number of enrollees (plus any standard surcharges). Other types of publications can be offered to the enrollees for additional fees. For example, a posting on a web page, to which an enrollee has access, can be available at no additional cost. However, an enrollee, who prefers to receive their findings in a letter, may be charged a fee to cover the cost of creating the letter.

In some embodiments, an initial price can be calculated at the time of publication based on the number of participants enrolled at the time of publication and the total cost of the research and publication. Following publication, participants cannot enroll to receive the findings at the initial price. Instead a premium price is charged to penalize participants for not enrolling prior to publication.

In some embodiments, following publication of the findings, participants who have not enrolled in a topic may obtain the results of the research (block 220). Fees are set at the final fee plus an additional amount. In some embodiments, the additional amount is set relatively high to create a greater value to participants who enrolled earlier and received the publication initially. In other embodiments, there is little or no additional fee as the reduction in price for every enrollee is an incentive to enroll prior to publication. In addition, in some embodiments, information that is time sensitive may be discounted over time. Changes in topics (e.g., new laws), requiring modification to the published information, may be provided at no or lower cost for a period of time to participants who have received the published information.

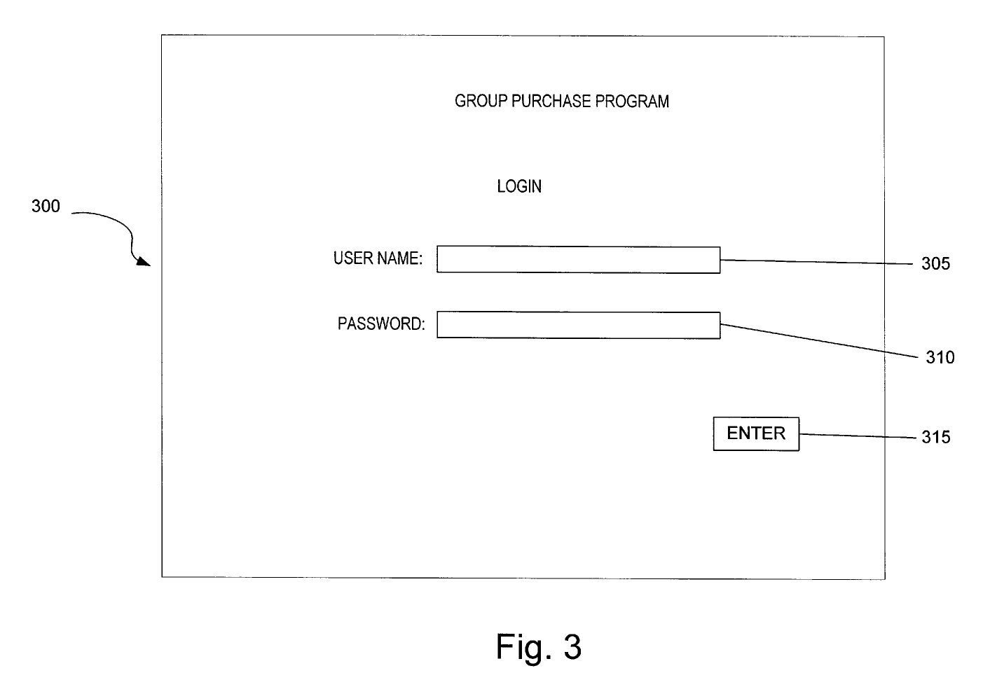

In some embodiments, a firm's home web page contains a link to a group purchase program page. FIG. 3 is an exemplary login screen 300 for an embodiment of a group purchase program. Each participant in the group purchase program can have a unique username and password. A group purchase program participant can enter their username in a username box 305 and their password in a password box 310. The participant can then click an enter button 315. If there is an error (e.g., the username or password is invalid) an error message appears to indicate what the error is.

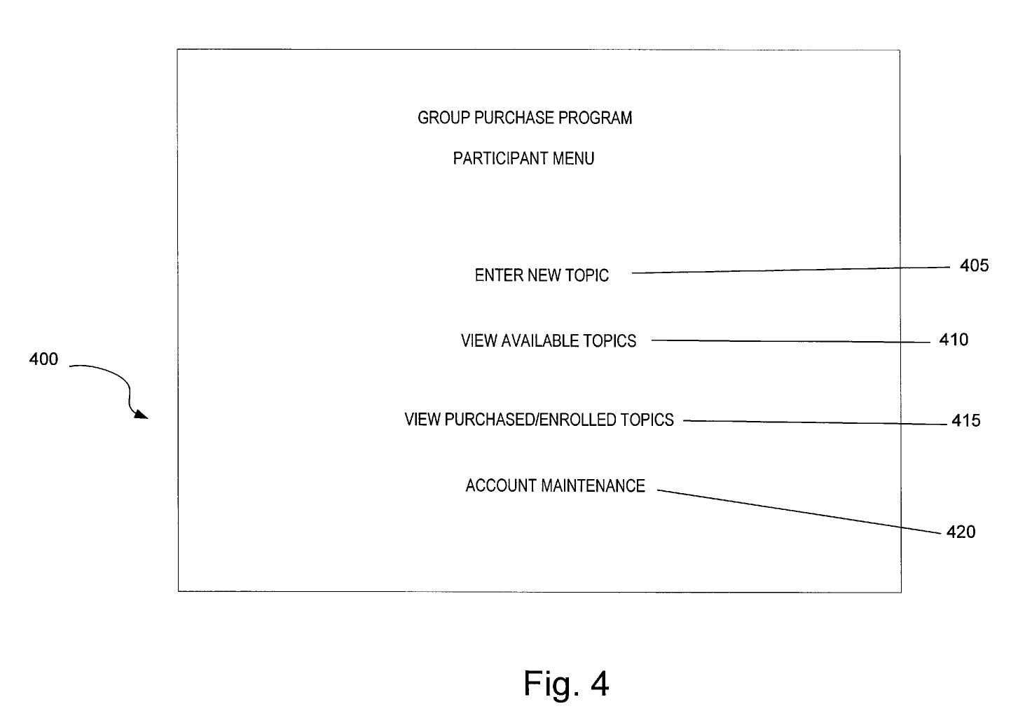

If a correct username and password for a participant is entered, a menu page 400 (FIG. 4) is displayed. In some embodiments, the menu choices include enter a new topic 405, view available topics 410, view purchased/enrolled topics 415, and account maintenance 420.

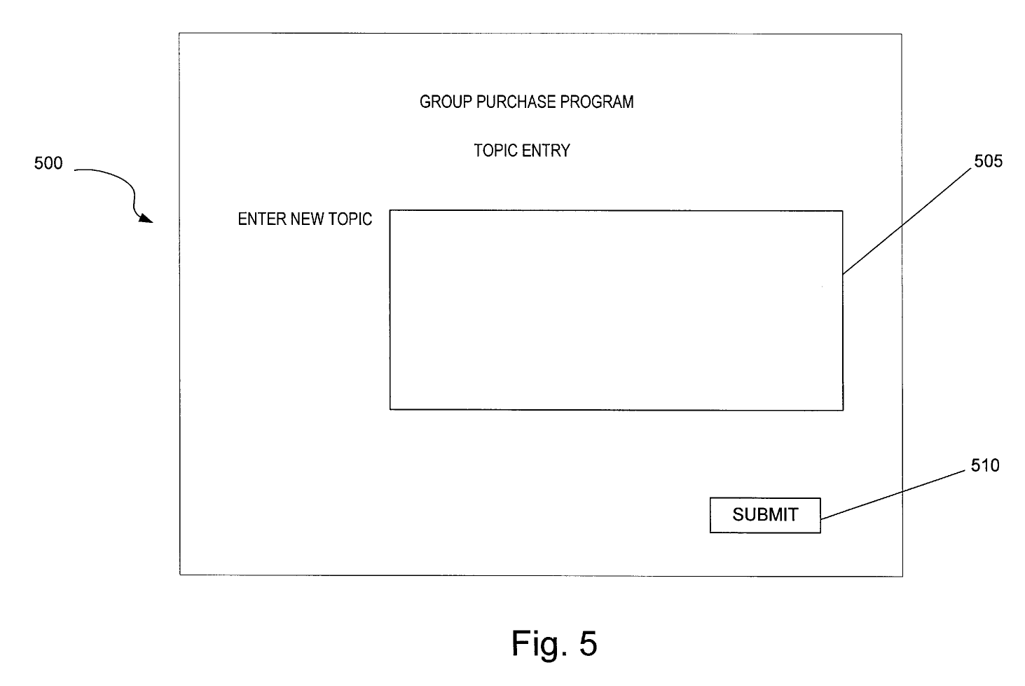

Clicking on enter new topic 405 displays a topic entry screen 500 as shown in FIG. 5. A text box 505 is displayed for entering a new topic. The participant can click in the text box 505 and a cursor appears in the text box 505. The user then types a new topic in the text box 505. Once the topic is entered into the text box 505 the participant clicks a submit button 510 to submit the topic. In some embodiments, topics can also be submitted by a written document, an email, and/or a direct conversation either to an attorney or to the administrator.

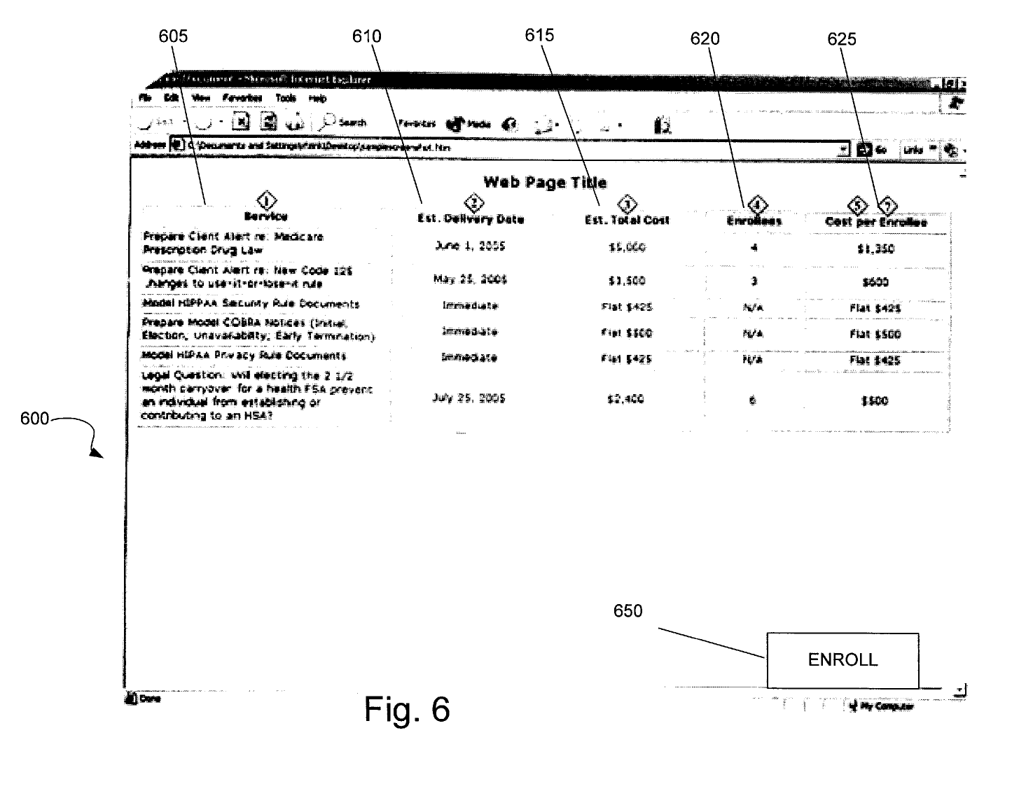

From the menu page 400, clicking on view available topics 410 displays an available topics screen 600 (FIG. 6). The available topics screen 600 display includes a list of topics 605, an estimated delivery date 610 for each topic, an estimated total cost 615 for each topic, a number of enrollees 620 for each topic, and a present cost per enrollee 625 for each topic. Participants purchase the data for a topic by enrolling in the topic. In some embodiments, a scroll bar allows participants to scroll through the available topics. In other embodiments, the available topics are available on one or more pages and a participant can view the list of available topics one page at a time.

The estimated delivery date 610 shows “Now” if a topic has been published and the estimated total cost 615 and enrollees 620 are blank. The cost per enrollee 625 displays the fixed purchase price for the topic.

In some embodiments, the list of topics can be sorted. Sorting criteria includes: estimated delivery date 610, area of application (i.e., employment), and/or by applicability to the participant.

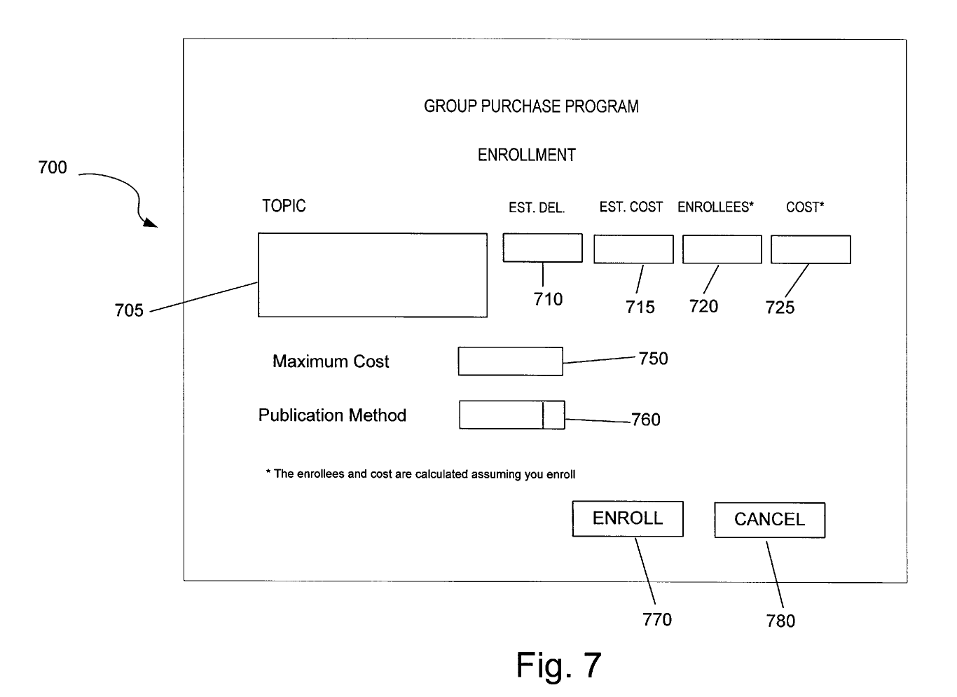

In some embodiments, a participant clicks on a topic to access functions related to the topic. If the topic has been published, a dialog box is displayed asking the participant to verify or cancel purchasing the topic. If the topic has not been published, an enrollment screen 700 (FIG. 7) displayed. The enrollment screen 700 contains information on a topic including topic 705, estimated delivery date 710, estimated total cost 715, number of enrollees 120, and estimated cost 725. The enrollment 720 and cost 725 reflect the number of enrollees and cost if the participant chooses to enroll. In addition, a maximum cost box 750 allows the participant to enter the maximum amount the participant is willing to pay for this topic. At the time the topic is published, if the calculated cost exceeds the maximum amount the participant entered, the participant can be given an opportunity to receive the topic at the higher cost.

A publication method pull down menu 760 allows the participant to choose how to receive the data on a topic when it is published. In some embodiments, the default entry is a web page. Other viable methods of publication can be listed along with any additional fees for receiving the data by that method. The participant clicks on the method of choice and this method will display in the box. The participant then clicks an enrollment button 770 to enroll in the topic or a cancel button 780 to not enroll in the topic.

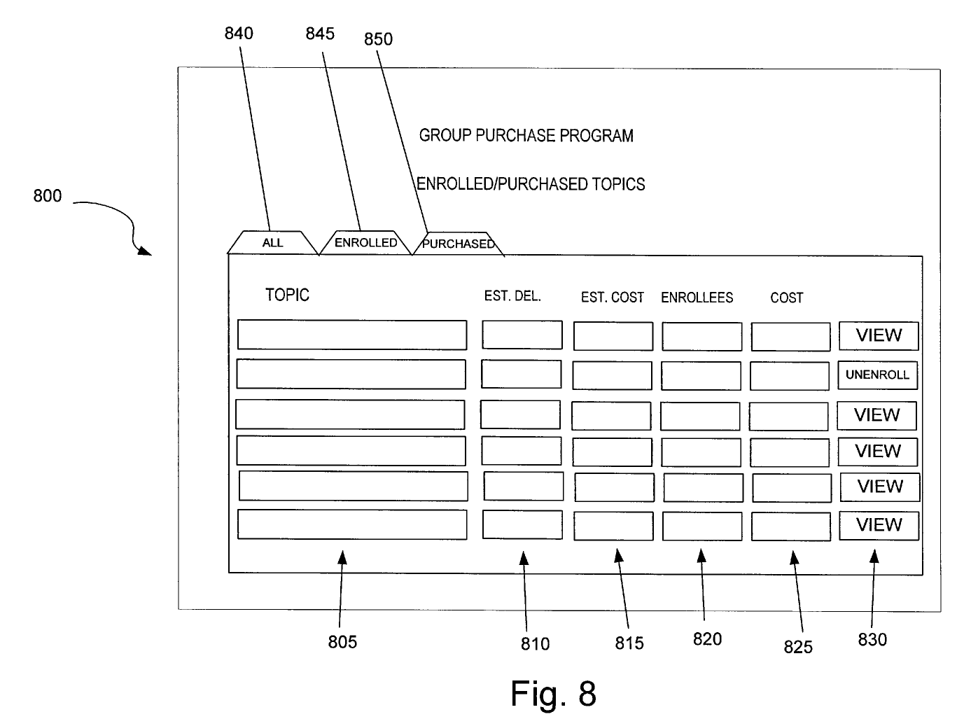

In some embodiments, clicking on the view purchased/enrolled topics button 415 from the menu screen 400 displays a purchased/enrolled topics screen 800 (FIG. 8). The purchased/enrolled screen 800 displays information on all of the topics the participant has enrolled in. The information displayed includes a topic 805, an estimated delivery date 810, an estimated total cost 815, a number of enrollees 820, and an estimated cost 825. In addition, a button 830 enables the participant to unenroll in topics the participant is enrolled in but which have not yet been published or to view topics, the participant has purchased, that have published.

In some embodiments, tabs allow the participant to choose which topics to view. Clicking an all tab 840 displays all topics in which the participant is enrolled in and has purchased. Clicking an enrolled tab 845 displays topics that have not been published that the participant has enrolled to receive. Clicking a purchase tab 850 displays topics that have been published and that the participant has purchased. In some embodiments, topics can be sorted by estimated delivery date 810 or practice area (not shown).

In some embodiments, clicking the account maintenance button 420 from the menu screen 400 displays an account maintenance screen (not shown). The account maintenance screen enables the participant to view and modify data relative to the participant's account. Modification of the account data can also be performed by the administrator. The participant, instead of modifying account data from the account maintenance screen, can inform the administrator 105 of data that the participant would like to have modified and the administrator 105 can make the modifications.

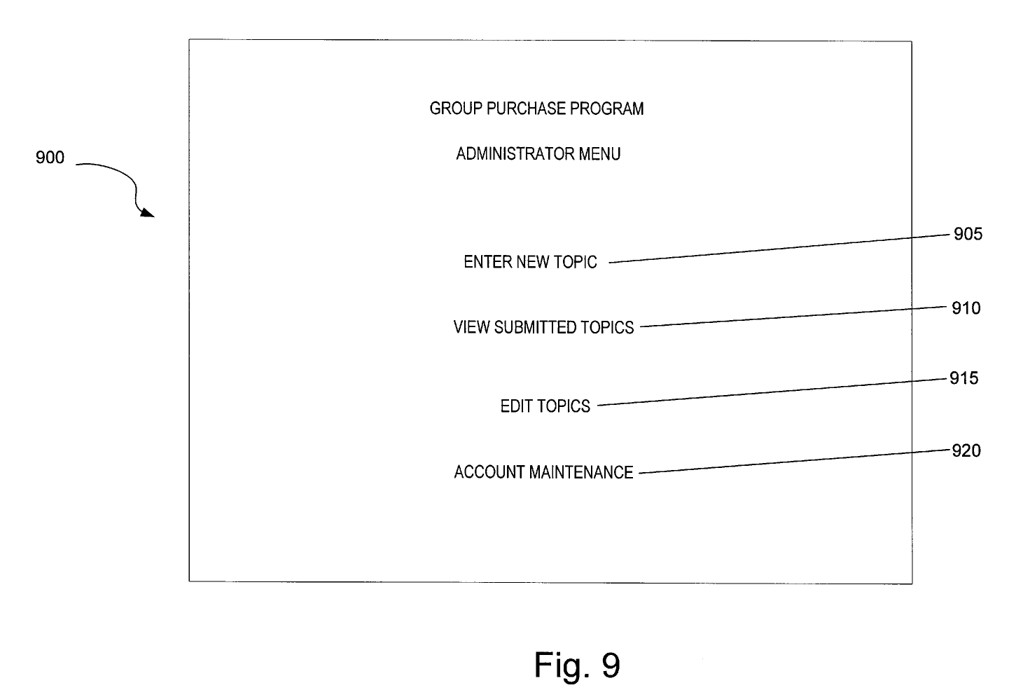

If, at the login screen 300, a correct username and password for an administrator is entered, an administrator menu 900 is displayed as shown in FIG. 9.

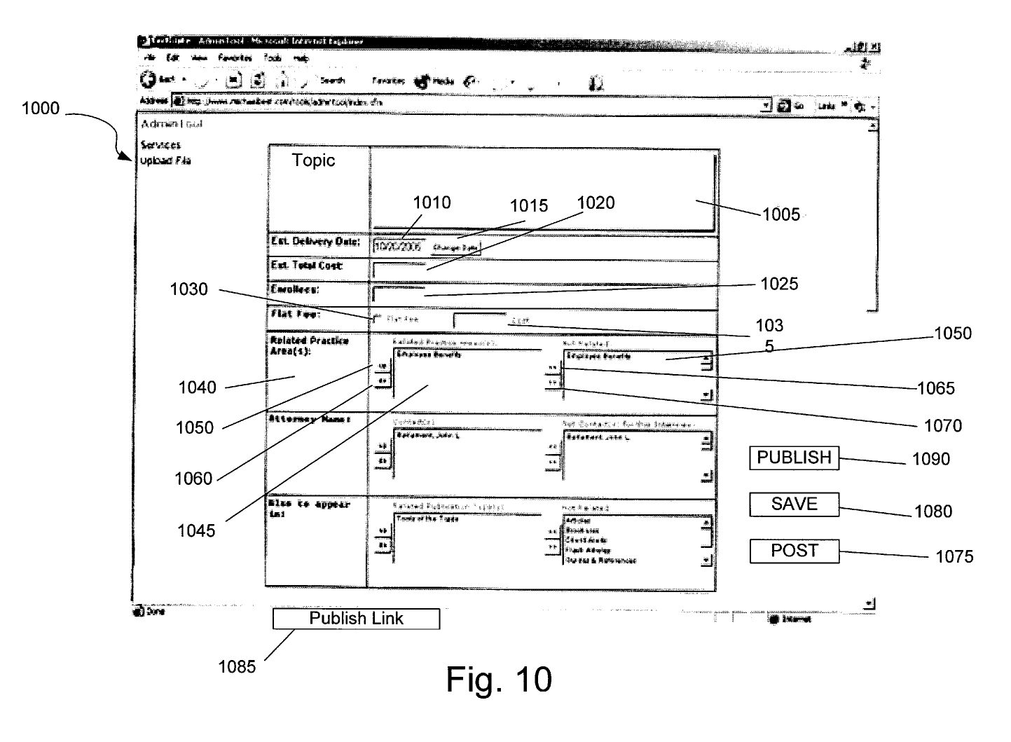

In some embodiments, clicking on an enter new topic button 905 displays a new topic screen 1000 (FIG. 10). Once a topic has been identified, budgeted, and classified, the administrator uses the new topic screen 1000 to enter new topics and post them for participants to enroll in.

A topic text box 1005 enables the administrator to enter a textual description of a topic. The administrator 105 clicks in the topic text box 1005 and a cursor appears. The administrator then types the topic description into the topic text box 1005. The text entered into the topic text box 1005 is the same as what is displayed in the view available topics screen 600 and view purchased/enrolled topics screen 800.

The administrator 105 enters an estimated delivery date into an estimated delivery date box 1010 or a calender button 1015 can be clicked to display a calender from which an estimated delivery date can be selected.

An estimated total cost box 1020 enables the administrator to enter the estimated total cost for researching and publishing or communicating data on the topic.

In some embodiments, a number of enrollees box 1025 is displayed. The administrator enters the number of participants that have enrolled to receive this topic. In other embodiments, the number of enrollees box 1025 is automatically filled when participants enroll to receive a topic.

Some topics can be provided for a flat fee. Topics can be offered at a flat fee initially or can be switched from an enrollment based fee to a flat fee after the topic has been published and delivered to enrolled participants. This enables participants to receive topics for which the participant did not have an initial interest but later developed a need or desire for. A select flat fee box 1030 is clicked to choose the flat fee option and a flat fee amount is entered into a flat fee amount box 1035.

In some embodiments, additional information is entered regarding the topic. Additional fields include relevant practice areas 1040, interested attorney name, other publications, relevant industry, relevant locations, and relevant entity size. In some embodiments a first box lists available options and a second box lists options chosen for each of the additional fields. For example, relevant practice areas 1040 includes a list of possible relevant practice areas 1045 and a list of selected relevant practice areas 1050. An up button 1055 scrolls the list of possible relevant practice areas upward in the list of possible relevant practice areas 1045. A down button 1060 scrolls the list of possible relevant practice areas 1045 downward in the list of possible relevant practice areas 1045. Clicking on a relevant practice area highlights the relevant practice area clicked on. Holding down the control (“CNTL”) key while clicking on a relevant practice area highlights the relevant practice area and leaves any other highlighted relevant practice areas highlighted. Other embodiments use a scroll bar to navigate up and down the list of possible related practice areas.

Clicking an include button 1065 can copy or move the highlighted relevant practice areas from the list of possible relevant practice areas 1045 to the list of selected relevant practice areas 1050.

In some embodiments, options in the list of selected relevant practice areas 1050 are highlighted in the same manner as the options in the list of possible relevant practice areas 1045. In embodiments where the relevant practice areas were moved from the list of possible relevant practice areas 1045 to the list of selected relevant practice areas 1050, clicking an exclude button 1070 moves the highlighted relevant practice areas in the list of selected relevant practice areas 1050 to the list of available relevant practice areas 1045. In embodiments where the relevant practice areas were copied from the list of available relevant practice areas 1045 to the list of selected relevant practice areas 1050, clicking the exclude button 1070 deletes the highlighted relevant practice area from the list of selected relevant practice areas 1050.

For each additional option field, the selected option box can be populated and unpopulated as described above for the relevant practice areas.

In some embodiments, once the topic 1005, estimated delivery date 1010, and estimated total cost 1020 (or flat fee 1035) have been entered and the appropriate options have been selected, a post button 1075 can be clicked to post the topic to the available topics list and allow participants to enroll in this topic. If the topic is not ready to post (e.g., the estimated total cost has not been determined), a save button 1080 can be clicked to save all of the entered information for later posting.

If the topic 1005 has been published, a link to a web page with the published data can be entered into a published link box 1085. The administrator 105 then clicks a publish button 1090 to change the status of the topic 1005 from posted to published.

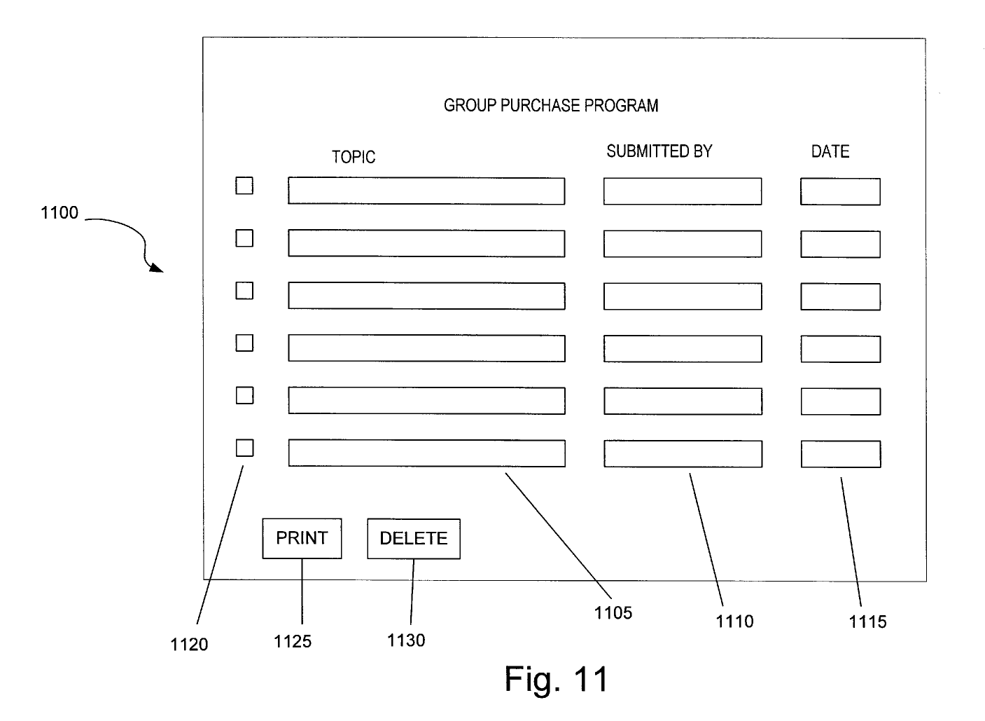

In some embodiments, clicking view submitted topics 910 displays a submitted topics screen 1100 (FIG. 11) showing topics that have been submitted by participants. A first box 1105 can show the topic, a second box 1110 can show the username of the participant who submitted the topic, and a third box 1115 can display the date the topic was submitted. The administrator 105 clicks a check box 1120 next to each topic the administrator 105 chooses to work with. The administrator 105 can then click a print button 1125 to print the selected topics with their related information. Once the selected topics have been printed, the administrator 105 can click on a delete button 1130 to remove the selected topics from the submitted topics list. Printed topics can then be provided to the topic identification function 125. In some embodiments, checked topics can be emailed to the topic identification function by clicking an email button (not shown) or saved, by clicking a save button (not shown), in a separate area for retrieval by the topic identification function.

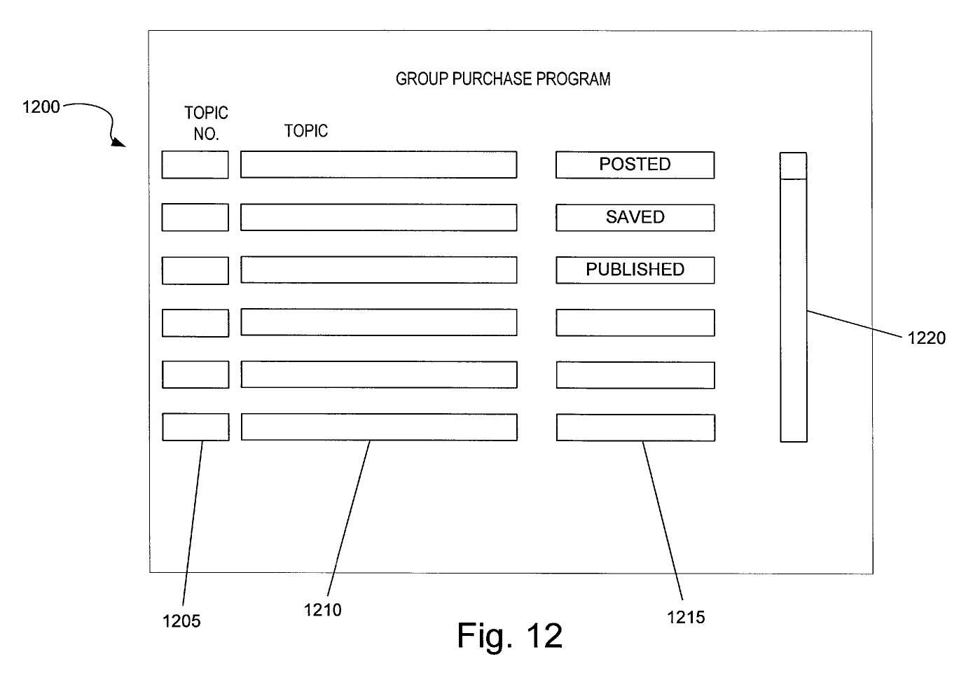

Clicking an edit topics button 915 displays a list of posted and saved topics as shown in FIG. 12. In some embodiments, a topic number 1205, a truncated topic 1210, and whether the topic is posted or saved (boxes 1215) is displayed. A scroll bar 1220 enables scrolling through the posted and saved topics. Double clicking on a topic displays the enter topic screen 1000 (FIG. 10) and any information entered previously for the topic. The information for the topic can then be modified and saved or posted as described above.

In some embodiments, the enter topics screen 1000 can display posted topics and saved topics separately. Tabs (not shown) can be used to select between the posted topics display and saved topics display.

Clicking an account maintenance button 920 enables the administrator to access and modify the participant database.

Thus, the invention provides, among other things, a method of dividing the cost of information amongst a group of interested parties and a system for providing the information to the interested parties. Various features and advantages of the invention are set forth in the following claims.

What is claimed is:

1. A method of providing information on a topic to a plurality of clients, the method comprising:
identifying a topic of interest;
developing a budget for producing a work product on the topic;
soliciting interest in the topic from the plurality of clients;
offering a right to receive the work product when available;
enrolling one or more of the plurality of clients in a program to receive the work product when available;
researching the topic;
publishing the work product;
providing the work product to the enrolled clients; and
billing the enrolled clients based on the budget, a number of enrollees, and a fixed fee.

2. The method of claim 1 wherein identifying a topic of interest includes one or more of framing the topic, developing a research budget, developing a publication budget, determining a delivery time, and categorizing the topic.

3. The method of claim 1 wherein soliciting interest in the topic includes one or more of posting the topic on a website, emailing one or more clients, calling one or more clients, and publishing a brochure on the topic.

4. The method of claim 1 and further comprising providing the work product to non-enrolled clients and billing the non-enrolled clients at a different rate than the enrolled clients.

5. The method of claim 1 wherein publishing the work product includes one or more of generating one or more web pages, generating an email message, and generating a letter.

6. The method of claim 1 and further comprising maintaining a database of previously published work product.

7. The method of claim 6 wherein the data base is accessible and searchable by a group of users, the group of users including attorneys and clients.

8. The method of claim 1 wherein a database of clients includes information on the clients'areas of interest.

9. The method of claim 8 wherein clients with an area of interest matching a category assigned to the topic are solicited for interest in the topic.

10. The method of claim 6 and further comprising reducing an amount of duplicated work product by determining if previously published work product exists for a new topic before researching the new topic.

11. The method of claim 1 wherein clients enroll via the Internet.

12. A system for sharing a cost of providing information on a topic amongst a group of interested participants, the system comprising:
a participant database comprised of potentially interested participants;
a topic database including a plurality of unresearched topics and a plurality of published work product; and
a computer system, the computer system configured to
receive a new topic,
provide the new topic to an identifying functiontion and receiving an identified topic from the identifying functiontion,
provide the identified topic to a research function and receiving a work product from the research function,
publish the work product,
enroll interested participants to receive the published work product,
provide the published work product to the enrolled participants wherein the enrolled participants share the cost of researching the topic and publishing the work product.

13. The system of claim 12 and further comprising providing previously published work product for a fixed cost.

14. The system of claim 12 wherein potentially interested participants pay a fee to join the participant database.

15. The system of claim 12 wherein a user accesses the system through the Internet.

16. The system of claim 12 wherein potentially interested parties submit new topics.

17. The system of claim 12 wherein identified topics are announced to potentially interested participants with a set of common interests.

18. The system of claim 12 wherein the topic, an estimated cost, and an estimated delivery time are provided to potentially interested participants.

19. A method of sharing a cost of providing a work product on a topic amongst a group of participants in a group purchase program, the method comprising:
submitting the topic to a group purchase program;
developing a research budget for the topic;
developing a budget for publication of the work product on the topic;
determining a delivery time for the published work product;
framing the topic;
categorizing the topic;
informing a select group of the group of participants about the topic;
researching the topic, the research generating information on the topic;
publishing the work product;
enrolling participants to receive the information; and
providing the published work product to the enrolled participants.

20. The method of claim 19 and further comprising providing the work product to interested participants who do not enroll for a fixed fee, the fixed fee greater than the shared cost.

21. The method of claim 19 wherein the work product is published in multiple formats.

22. The method of claim 19 wherein the enrolled participants elect a format to receive the work product in.

23. The method of claim 21 wherein each format has an associated cost.
